(19) United States
(12) Patent Application Publication
(10) Pub. No.: US 2014/0365180 A1
(43) Pub. Date: Dec. 11, 2014

(54) OPTIMAL SELECTION OF BUILDING COMPONENTS USING SEQUENTIAL DESIGN VIA STATISTICAL BASED SURROGATE MODELS

(71) Applicants: Carnegie Mellon University, Pittsburgh, PA (US); International Business Machines Corporation, Armonk, NY (US)

(72) Inventors: Khee Poh Lam, Pittsburgh, PA (US); Young Min Lee, Old Westbury, NY (US); Fei Liu, Scarsdale, NY (US); Jane L. Snowdon, Greenwich, CT (US); Jeaha Yang, Stamford, CT (US); Rui Zhang, Ossining, NY (US)

(73) Assignees: Carnegie Mellon University, Pittsburgh, PA (US); International Business Machines Corporation, Armonk, NY (US)

(21) Appl. No.: 13/910,251

(22) Filed: Jun. 5, 2013

(51) Int. Cl. G06F 17/50

(52) U.S. Cl. CPC G06F 17/5004
USPC 703/1

(57) ABSTRACT

A surrogate model to a building simulation model is built and used for finding a combination of building components that optimize energy use in a building. The surrogate model may be built iteratively using design points comprising a different combination of building product properties that maximize a predefined expected improvement function.

### STATEMENT REGARDING FEDERALLY SPONSORED RESEARCH OR DEVELOPMENT

This invention was made with Government support under Contract No.: 4352-IBM-DOE-4261 awarded by Department of Energy. The Government has certain rights in this invention.

### FIELD

The present application relates generally to building design and retrofit, energy use in building, design and operation of energy efficient buildings, and more particularly to selecting building components, for example, using a computerized statistical optimization model, for instance, for providing efficiency in building energy use, operation and/or material costs, and/or cleaner environment.

### BACKGROUND

The enclosure that physically separates the interior of the building from the exterior or outdoor environment is referred to as the building envelope. Examples of such physical separators include the walls, roof, windows, doors, foundation and others. The building envelope is considered the main source of heat loss and gain, and hence greatly impacts building heating and cooling energy consumptions. In designing buildings, choosing the optimal combination of building envelope components that minimize heat transfer between the outdoors and the building may also reduce investment and operational costs. While, building simulation tools such as EnergyPlus™ can be used in estimating energy consumption in buildings by simulation, the approaches taken therein and other traditional approaches often require a massive number of evaluations of energy simulation models. Such approaches have high computational cost, especially in a realistic environmental context, as the search space is usually very large. While most studies point out that building energy simulation is expensive, there is still a lack of efficient methods which can reduce this simulation cost.

In addition, the set of input parameters often contains both continuous and discrete variables, as most variables in real envelope design problems are discrete in nature. For example, consider glass as one the building envelope material. There are only a finite number of types of glass materials available, which take finitely many values in each defining feature. Moreover, the different properties of glass are not independent of each other and can only take on a given set of combinations.

### BRIEF SUMMARY

A method of identifying a combination of building components for building installation, in one aspect, may comprise generating initial design points comprising a combination of building product properties by space-filling design. The method may also comprise obtaining an energy performance simulation result by running a building simulation model at the initial design points. The method may further comprise building a statistical surrogate model based on the initial design points and the energy performance simulation result by a Gaussian process, wherein the Gaussian process represents a response surface that models input-output relationship providing the statistical surrogate model to the building simulation model. The method may also comprise determining new design points comprising a different combination of building product properties to maximize a predefined expected improvement function. The method may further comprise obtaining new energy performance simulation result by running the building simulation model at the new design points. The method may further comprise refitting the statistical surrogate model to the new energy performance simulation result. The method may also comprise iterating the determining of new design points, the obtaining of new energy performance simulation result, and the refitting of the statistical surrogate model, until a criterion is satisfied.

A system for identifying a combination of building components for building installation, in one aspect, may comprise a building component selection module operable to execute on the processor and further operable to generate initial design points comprising a combination of building product properties by space-filling design. The building component selection module may be further operable to obtaining an energy performance simulation result by running a building simulation model at the initial design points. The building component selection module may be further operable to build a statistical surrogate model based on the initial design points and the energy performance simulation result by a Gaussian process, wherein the Gaussian process represents a response surface that models input-output relationship providing the statistical surrogate model to the building simulation model. The building component selection module may be further operable to determine new design points comprising a different combination of building product properties to maximize a predefined expected improvement function. The building component selection module may be further operable to obtain a new energy performance simulation result by running the building simulation model at the new design points. The building component selection module may be further operable to refit the statistical surrogate model to the new energy performance simulation result. The building component selection module may iterate determining of the new design points, obtaining of the new energy performance simulation result, and refitting of the statistical surrogate model, until a criterion is satisfied.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 illustrates an overview of a statistics optimization methodology of the present disclosure in one embodiment.

FIG. 2 illustrates a method for initial design in statistical surrogate modeling in one embodiment of the present disclosure.

FIG. 3 illustrates a method for sequential design in statistical surrogate modeling in one embodiment of the present disclosure.

FIG. 4 illustrates computation of input uncertainty in material degradation in one embodiment of the present disclosure.

FIGS. 5A and 5B visualize the tradeoff between local minima and uncertainty about an example fitted surrogate model for a one-dimensional function ƒ in one embodiment of the present disclosure.

FIG. 6 is a flow diagram illustrating a method for service rendering, e.g., via a CAD interface, for statistic surrogate model in one embodiment of the present disclosure.

FIG. 7 illustrates a method for service rendering model for building energy simulation model composer in one embodiment of the present disclosure.

FIG. 8 illustrates a service usage model in one embodiment of the present disclosure.

FIG. 9 is a flow diagram illustrating a service rendering model for manufacturers' websites in one embodiment of the present disclosure.

FIG. 10 illustrates a schematic of an example computer or processing system that may implement a building component selection system in one embodiment of the present disclosure.

### DETAILED DESCRIPTION

An embodiment of the present disclosure generates a statistical surrogate model for an energy simulation model and updates this model using new observations based on a sequential design of experiments. At the beginning of the algorithm, the energy simulation model may be executed on an original space-filling design in order to build a statistical surrogate model in the form of a response surface defined on the input space of the energy simulation model. An expected improvement function then may guide the search for the optimal combination in a sequential design step: A new design point may be defined as the vector of input parameter values that maximizes a predefined expected improvement function. The energy simulation model may be then executed at the new design point and the surrogate model may be updated to incorporate the result at the new design point. The algorithm may iterate between the surrogate model building step and the sequential design step, e.g., until the increase of the expected improvement function becomes negligible (e.g., meets a defined threshold). The statistical surrogate model may allow for faster estimation of the building's optimal energy consumption by reducing the number of energy simulation model runs required, and hence also allow for reduction in computational cost. The approach of the present disclosure in one embodiment reduces the computational complexity involved in the building simulation models.

Generally a simulation model describes an input-output relationship. As the model gets exceedingly complex, the simulation model is often treated as a “black box”. A surrogate model of the present disclosure in one embodiment may be built using the Gaussian surface approach which provides scalar output. A Gaussian process is assumed as the prior distribution of the simulation model. Given a collection of runs obtained by executing the simulation model, applying the Bayesian updating mechanism of learning, an embodiment of the present disclosure may obtain the posterior distribution of the simulation model. The posterior distribution may be then used as a surrogate model to the simulation model. For example, at any untried input values, an embodiment of the present disclosure can obtain the posterior distribution of the corresponding simulation model output. The surrogate model of the present disclosure in one embodiment may provide a mean estimate of the simulation output, and also the associated uncertainty at the new input.

In another aspect, a surrogate modeling in the present disclosure may utilize a nonparameteric model which may include space-filling designs such as maximum distance designs and Latin Hypercube designs, derived to minimize distances such as the distance between an arbitrarily selected point and the training points in the input space. In yet another aspect, an embodiment of the present disclosure may utilize a sequential design strategy of computer experiments in providing a building simulation model. Under the sequential design strategy, inputs are selected sequentially so that improvements over the current optimal input are expected to be large. A sequential design uses fewer runs of the simulation model, thus reducing building simulation related computational cost.

Generally, a methodology of the present disclosure in one embodiment may comprise an initial design of experiment, the construction of a statistical surrogate model, and a sequential design approach for search of an optimal solution. Such methodology may find an optimal combination of building envelopes that minimize energy consumption in buildings. For example, a building enclosure design using sequential design methodology via one or more statistical surrogate models of the present disclosure in one embodiment may minimize energy consumption, for instance, Energy Use Intensity (EUI), which is defined as energy use per floor area.

Consider the following scenario as an example to illustrate a methodology of the present disclosure in one embodiment. In search of an optimal envelope design, a high dimensional variable space may be considered that comprises alternative materials for the external wall insulation, roof insulation, different glazing types and different infiltration levels. The variables under consideration in this example and their corresponding example ranges are listed in Table 1. The insulation materials' R values are obtained from manufacturers' product catalogues. The upper bound of the wall insulation thickness is the thickness required to obtain an R value of R-60. The thickness range of the roof insulation is based on the thickness required to achieve an overall R value of R-5 to R-90. The infiltration range is selected based on infiltration values in reference building models for offices. The properties of the glazing materials are obtained from a database of 2695 types of glass available from manufacturers. The variables related to glass are taken as categorical variables, and can only take the combination of values represented among the 2695 types. Since optical properties of glass are interrelated, constraints on these variables are also defined. Given the above example, a formulation of an optimization problem may be defined as follows:

$$\begin{matrix}\begin{matrix}{minimize}_{x} & EUI ( x )\end{matrix} & \\ \begin{matrix}subjectto & {x}_{7} + {x}_{8} \leq 1 , \\ & {x}_{7} + {x}_{9} \leq 1 , \\ & {x}_{10} + {x}_{11} \leq 1 , \\ & {x}_{10} + {x}_{12} \leq 1 , \\ & x \pm L , x°U ,\end{matrix} & \end{matrix}$$

where, X⊂P^{p}, p=15 is the vector of independent variables, as listed in Table 1.
EUI:X→P is the cost function, given input vector x. L,U⊂P^{P} are the lower and upper bounds of the variables, which are listed in Table 1.

Table 1 below illustrates an example of the variable space for optimal building envelope design, and the ranges of the variables.

TABLE 1

| | | | |
|---|---|---|---|
| Variable xᵢ | Variable Description | Lower bound | Upper bound |

Wall insulation:

| | | | |
|---|---|---|---|
| x₁ | Thickness (m) | 0.05 | 0.526 |
| x₂ | R Value (K · m²/W) | 0.51 | 2.21 |

Roof insulation:

| | | | |
|---|---|---|---|
| x₃ | Thickness (m) | 0.091 | 0.343 |
| x₄ | R Value (K · m²/W) | 0.51 | 2.21 |
| x₅ | Infiltration: (m³/s · m²) | 0.00012 | 0.0012 |

Glazing:

| | | | |
|---|---|---|---|
| x₆ | Thickness (mm) | 0.038 | 26.67 |
| x₇ | Solar transmittance (%) | 0.0003 | 0.91 |
| x₈ | Front solar reflectance (%) | 0.03 | 0.83 |
| x₉ | Back solar reflectance (%) | 0.03 | 0.81 |
| x₁₀ | Visible transmittance (%) | 0.0 | 0.92 |
| x₁₁ | Front visible reflectance (%) | 0.01 | 0.70 |
| x₁₂ | Back visible reflectance (%) | 0.01 | 0.72 |
| x₁₃ | Front infra-red hemispherical | 0.01 | 0.96 |
| | emissivity (%) | | |
| x₁₄ | Back infra-red | 0.01 | 0.96 |
| | hemispherical | | |
| | emissivity (%) | | |
| x₁₅ | Conductivity (W/m · k) | 0.13 | 1.01 |

Computational cost is a limitation for efficiently employing a simulation model for building design and retrofit. Computation time of building energy simulation is dependent on the complexity of building configurations such as building geometry and mechanical systems, and the algorithm used in the simulation program. Simulation time for a single model typically ranges from a few minutes (4 to 5 minutes) to more than an hour. An exhaustive search that would run a simulation model for all possible combinations of materials/components (e.g., 2695 possible feature combinations for glass material, combined with continuous values for wall and roof materials) is expensive and may not be feasible. To overcome this difficulty, an embodiment of the present disclosure introduces a statistical surrogate modeling approach.

In the present disclosure in one embodiment, a statistical approach such as the Gaussian Response Surface Approximation (GASP) method may be used to handle computationally expensive deterministic simulation models (e.g., EnergyPlus™ simulation model). It treats the simulation model as an unknown function describing the input-output relationship between model parameters and EUI. A Gaussian process is then assigned as the prior distribution of the unknown function. Initial runs of the simulation model are selected according to a specified design criterion. The corresponding outputs, together with their inputs are then used to update the posterior distribution of the unknown function. This yields a response surface of the simulation model over the entire input parameter space, which provides the predictive distribution of the simulation model at any model input. The response surface, or the predictive distribution of the simulation model, is referred to as a statistical surrogate model to the simulation model. Evaluating the response surface is very fast, and therefore, the surrogate model may be used for further analysis, instead of the computationally expensive simulation model. For example, the response surface is evaluated in real time, for instance, given a set of input, the corresponding output is obtained in real time. In one aspect, no physical simulation need be performed when evaluating the response surface; Physical simulation is only performed during the construction of the response surface. For instance, the response surface takes a number of sets of inputs and corresponding outputs obtained by running the physical models. Then a model similar to regression models may be built to capture the relationship between the inputs and outputs. The next time a set of input is received, instead of running the physical model, the response surface model provides an estimate of the output corresponding to the given input.

Let p be the number of input parameters the user specifies for a simulation module (e.g., the EnergyPlus™ model). Denote the feasible space for the input parameters of the model by X, X⊂R^{p}. Let Y(xᵢ) denote the simulation module output, where xᵢ=(xᵢₗ, . . . , xᵢₚ)εX. The prior distribution for the response Y(•) takes the following form

Y(•):GP(μ,σ²c(•,•)),

where μ is the mean, σ² is the variance, and c(•,•) is the correlation function of the Gaussian process GP(μ,σ²c(•,•)). The Gaussian process models data observed over space. It has the property that the joint distribution of Y(•) at a finite set of points x₁, . . . , xₙ has a n-dimensional multivariate normal distribution, for which the covariance between Y(xᵢ) and Y(xⱼ) is equal to σ²c(xᵢ, Xⱼ). In the present disclosure, a separable form of the correlation function is defined as

$$c ( {x}_{i} , {x}_{j} ) = exp ( - {\sum }_{k = 1}^{p} {β}_{k} {\vert {x}_{ik} - {x}_{jk} \vert}^{{α}_{k}} ) .$$

Where: βₖ and αₖ are statistical parameters that will be estimated by the data.

Let X=(x₁, . . . , xₙ) be a design of the input parameters (e.g., a collection of input vectors) and Y be the vector of corresponding outputs. Consider a specific input x at which Y(x) has not been observed. Let ρ be the n-dimensional vector with the i th element c(x, xᵢ) and Σ be the n×n matrix with the (i, j) element c(xᵢ, xⱼ). The posterior predictive distribution for Y(x) can be written as

[Y(x)|X,Y]:N(\hat{μ}(x),ŝ²(x)),

where

\hat{μ}(x)=Σ⁻¹ρ′Y, and \hat{s}(x)=σ²(1−ρ′Σ⁻¹ρ). (1)

The model parameters may be estimated in the Gaussian process using a statistical software tool, e.g., R (R Core Team 2012), more specifically, mlegp function in R. Mean and variance in (1) can be evaluated at all possible input vector at negligible computational cost. This Gaussian process represents a response surface which models the input output relationship, providing a statistical surrogate model to a simulation model.

To build the initial surrogate model, an initial design is obtained for a simulation model. The initial design is set of inputs for the building energy simulation model (EnergyPlus™). With our example problem setting of 15 parameters, we will use 100 set of inputs as initial design. One set of parameter values (xδR¹⁵) is called a design point in the initial design space (R^{p}). The following will describe the method to obtain the initial design of 100 points as an example.

When there is no prior information on the functional behavior of the response, it is appealing to spread out design points uniformly over the input space, as interesting features of the simulation model are equally likely to appear across the input space. Briefly, design points refer to sample input points to the simulation model, e.g., various combinations of building product components. A space-filling design is used in one embodiment of the present disclosure for initial planning of an energy simulation.

For xᵢ,xⱼεR^{P}, let d be the Euclidean distance defined by

$$d ( {x}_{i} , {x}_{j} ) = {( {\sum }_{k = 1}^{p} {\vert {x}_{ik} - {x}_{jk} \vert}^{2} )}^{1 / 2} . \qquad ( 2 )$$

A criterion function based on d is

$$a . {φ}_{λ} ( X ) = {[ {\sum }_{{x}_{i} , {x}_{j} ∈ X} {d ( {x}_{i} , {x}_{j} )}^{- λ} ]}^{1 / λ} \qquad ( 3 )$$

with a positive integer λ. Note that a design X* minimizing ((3)) for λ=∞ is called maximum distance design and satisfies

$${min}_{{x}_{i} , {x}_{j} ∈ {X}^{*}} d ( {x}_{i} , {x}_{j} ) = {max}_{X ⋐ X} {min}_{{x}_{i} , {x}_{j} ∈ X} d ( {x}_{i} , {x}_{j} ) . \qquad ( 4 )$$

An initial design may be obtained for a given λ by first generating a random design and then sequentially improving the overall design via optimizing the maximum distance of one individual point while fixing the remaining points. For a design X of n runs, define Xᵢ to be a design of n−1 points (excluding the i th point), and define Xᵢ(x) as design Xᵢ augmented by a new input x. Therefore the minimum distance of all the design points φ_{λ}(Xᵢ(x)) (Equation 3) is a function of x only, as the remaining n−1 points are fixed. Now n reduced Sᵢ problems (the problem of finding the xᵢ that maximize the minimum distance of all the points in the initial design space) is presented as

Sᵢ: arg min_{xεX}φ_{λ}(Xᵢ*(x)) (5)

Let x* be the solution of Sᵢ and Xᵢ* the design Xᵢ augmented by x*.

Algorithm 1 illustrates a pseudo code that may implement an initial design of a surrogate model in one embodiment of the present disclosure.

Algorithm 1

Define initial solution X ;
φ_{old} := φ_{λ}(X) ;
while improvement >∈ do
improvement := 0 ;
for i = 1 to N do

solve Sᵢ ;
improvement := φ_{old} − φ_{λ}(Xᵢ*) ;

φ_{old} := φ_{λ}(X*ᵢ);
X := X*ᵢ ;

end for
end while

Each Sᵢ is solved as one xᵢ is updated at a time. The selection of λ may depend on the specific problem, such as the dimension and size of the design. The constrained optimization for Sᵢ may be performed, e.g., using a computer-implemented statistical tool (e.g., R Core Team), for instance, constrOptim function in R.

Once the initial design is established, for example, as described above, a sequential design process may take place. For instance, the response surface of the surrogate model is utilized to solve the global optimization problem of finding the optimal combination of building components. The search space may be explored according to a strategy that balances local and global search. On the one hand, the search should explore component combinations that promise the lowest EUI according to the surrogate model. Following this strategy would however may result in a local minimum close to observed locations in the search space. Globally, on the other hand, it may be preferable to explore areas in the search space where uncertainty about the response behavior is still great. In one embodiment of the present disclosure, the two positions may be balanced using the concept of expected improvement, e.g., by the following expectation, for a given input vector x (building component thermal parameters, to be used in the building energy simulation model):

E[I(x)]=E[max(yₘᵢₙ−Y,0)], (6)

where yₘᵢₙ=min{Y} is the smallest function value among all observed responses. Here, yₘᵢₙ represents the smallest EUI and Y represents current EUI. The different Y values are produced by different surrogate models resulting from different design points. In the case of a Gaussian process response surface, this expectation can be computed as

$$E [ I ( x ) ] = ( {y}_{m i n} - \hat{μ} ( x ) ) Φ ( \frac{{y}_{m i n} - \hat{μ} ( x )}{\hat{s} ( x )} ) + \hat{s} ( x ) φ ( \frac{{y}_{m i n} - \hat{μ} ( x )}{\hat{s} ( x )} ) \qquad ( 7 )$$

using the parameter estimates derived according to Equation (1). Here, Φ is the distribution function of a standard normal distribution, and φ is the corresponding density function. Y values represent EUI, and x values represent the building component parameters.

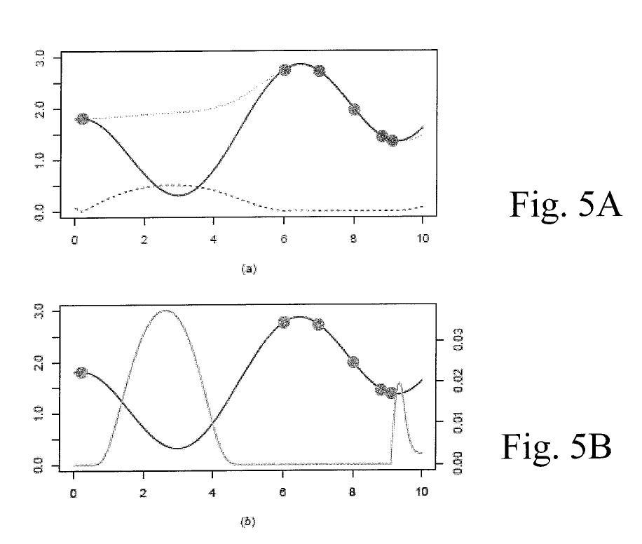

As an example, FIGS. 5A and 5B visualize the tradeoff between local minima and uncertainty about the fitted surrogate model for a one-dimensional function ƒ. In FIG. 5A, the X-axis represents the input parameters in 2-dimensional (2-D) space, and the Y-axis represents the function values. FIG. 5A shows a fitted model (dotted line) of an unobserved function (solid line) plotted along standard error estimates for fitted values (dashed line, FIG. 5A)). FIG. 5B shows the unobserved function (solid line) contrasted with expected improvement (grey line, FIG. 5B)). In FIG. 5B, X-axis represents the input parameters in 2-dimensional (2-D) space, and the Y-axis represents the expected improvement. Red dots represent the observed responses that have been obtained by evaluating ƒ at selected sample points. Based on the fitted response surface (dotted line) only, one might expect the minimum of ƒ to be at x=9.4. However, the uncertainty about the response, expressed as the standard error of the fitted value \hat{μ}(x), is greatest between 2 and 4 (dashed line in FIG. 5A). The expected improvement according to Equation (7) is represented as a grey line in FIG. 5B. Balancing uncertainty about the response and a small value of \hat{μ}(x) leads the search algorithm to suggest a new exploration point at x=2.6, the point at which the expected improvement is maximized.

To find the x* which maximizes the expected improvement, available functions for optimization of continuous functions with constraints, such as the function optim( ) in R may be used, using the method=“L-BFGS-B” option for the Brouden, Fletcher, Goldfarb and Shanno method with box constraints. In this particular example, however, the variables encountered are discrete, and only K=2695 distinct combinations of these variables (“slices”) were used. The combination of variables that leads to the greatest expected improvement may thus found in two stages. Let X^{(k)} be the feasible space of parameter values in which the variables corresponding to the discrete product (e.g., glass) characteristics are fixed at combination k, kε1, . . . , K. In the first stage, for each k, an expected improvement may be maximized over all continuous variables. In the second stage, the maximum expected improvement may be compared across all slices and the combination with the greatest expected improvement may be chosen.

Algorithm 2 illustrates a pseudo code for finding an optimal combination of building components in an iterative fashion. After fitting the surrogate model to the observations obtained at the initial design X, the optimization stage finds the new design point x* that maximizes the expected improvement across all slices. Slices refer to discrete variables, for example, the discrete variables may be data points in 1-D (dimension), lines in 2-D, surfaces in 3-D, and etc. A simulation model such as EnergyPlus™ then may evaluate the model at the new design point, and the new response Y(x*) is added to the data set. The surrogate model is refit to the augmented data, and the steps of optimization, model simulation and surrogate model rebuilding are iterated until one of several stopping criteria is met. A stopping criterion may be that the expected improvement is smaller than a threshold value. For example, if the expected improvement of a new variable combination is (a) less than a small fraction tₐ (e.g., 1%) of the current minimum EUI or (b) smaller than a pre-defined meaningful threshold t_{b} (e.g., 0.05), the search terminates. For practical reasons and limitations on total computation time of the entire search, the search may also be stopped if it has not resulted in any actual improvement of EUI in a given number of simulations, or has exceeded an acceptable number of iterations.

Algorithm 2

Y = EUI(X);
StoppingCriterion := FALSE;
While StoppingCriterion = FALSE do
fit surrogate model Y | X, Y ;
for k = 1 to K do

xₖ* := argmax_{x∈×}_{^{(k)}}E[I(x)];

end for

x* := argmax_{x∈{x}_{₁}_{*,...,x}_{_{K}}_{*}} E[I(x)];

if E[I(x)] < yₘᵢₙ ·tₐ or E[I(x*)] < t_{b} then

StoppingCriterion := TRUE;

else

```
  y* = EUI(x*) ;
  X = X(x*) ; Y = (Y, y*)′ ;
```

end if
end while

The methodology of the present disclosure, including e.g., the Algorithms 1 and 2 above, may run in R (R i386) and EnergyPlus™ on, for example, Windows™ 7 machine with Intel Core Duo™ CPU @ 2.40 GHz processor.

A statistics and physics based sequential design method of the present disclosure may provide recommendation of optimal combination of building products that minimize investment and operating cost over product life span, incorporating for example, factors such as degradation of material and product properties. Material degradation affects the energy use, and therefore, the analysis in one one embodiment of the present disclosure also takes into account the material degradation and the associated uncertainty. An example objective function for such optimization may be defined as follows:

$$f ( x ) = {\sum }_{t} {w}_{t} {y}^{M} ( {x}_{t} ) + RC ( {x}_{0} )$$

$$EU = {y}^{M} ( {x}_{t} )$$

where wₜ represents energy unit price at year t; xₜ represents material properties at year t; y^{M}(•) represents energy simulation model; and RC(•) represents retrofit cost. EU represents energy consumption under parameter set xₜ at year t, where parameter set xₜ=(xₜ¹, xₜ², . . . , xₜ^{t}) includes, but not limited to:
xₜ¹—building type (e.g., large office, full service restaurant, etc);
xₜ²—building size (e.g., sq. ft.);
xₜ³—building address (e.g., used to get weather information for the building energy simulation model)
Xₜ⁴—building built year (e.g., before 1980, after 1980, new construction)
Xₜ⁵—user preference set point temperature for summer and winter;
xₜ⁶, xₜ⁷, . . . , xₜ^{k}—building components properties (each building component has a set of predefined properties).

An optimal combination of building products may be expressed as x=argminₓƒ(x). In the above example objective function, in one embodiment of the present disclosure, y^{M}(•) is evaluated by the surrogate model of the present disclosure.

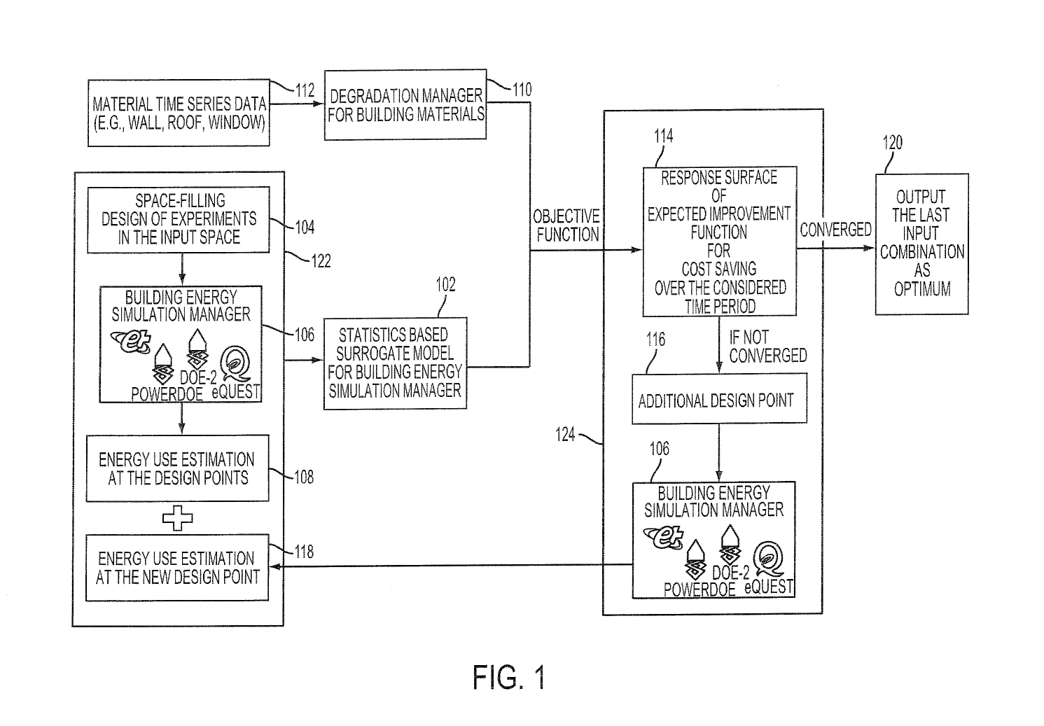

FIG. 1 illustrates an overview of a statistics optimization methodology of the present disclosure in one embodiment. As described in detail above, a surrogate model 102 may be built based on initial design and also using a sequential design technique. The surrogate model 102 may be initially built using a space-filling design 104 of experiments in the input space for initial planning of an energy simulation. The initial design may comprise space-filling design of experiments in the input space 104, which is used to run a building simulation model 106, which in turn produces the energy use estimation at those design points 108. The space-filling design points 106 and the corresponding energy use estimation 108 are used to estimate the model parameters, e.g., in the Gaussian process, which models the an input-output relationship (the surrogate model) 102. Degradation information 110 about various materials may be obtained from material time series data 112. The surrogate model 102 and the degradation information 110 may be used to build an objective function (e.g., shown above) that incorporates the material degradation during its life cycle. Response surface of expected improvement function for cost saving over a considered time period 114 is obtained. As described above, the expected improvement function balances the local and global search. If the response surface 114 of this current simulation run does not converge (e.g., with respect to the previous response surface obtained from a previous iteration run of the simulation model), additional design points 116 are obtained, and the simulation model 106 is run with the additional design points 116. The additional design points 116 are those that maximize the expected improvement. The energy use estimation at the new design point 118 output from the simulation 106 is used with the previous output 108 in modeling parameters in the Gaussian process, and the surrogate model 102 is updated or rebuilt with this new input-output relationship of the Gaussian process. On the other hand, if the response surface of expected improvement function for cost saving over the considered time period 114 converges, the last set of input combination is output 120 or recommended as an optimum combination of building components.

In another aspect, the iteration of rebuilding the surrogate model may stop, even if there is no convergence at 114, e.g., based on a different criterion. Examples of such criterion may include, but not limited to: a defined maximum number of iterations has exceeded, no actual (or very small) improvement of EUI in a given number of iterations, and others.

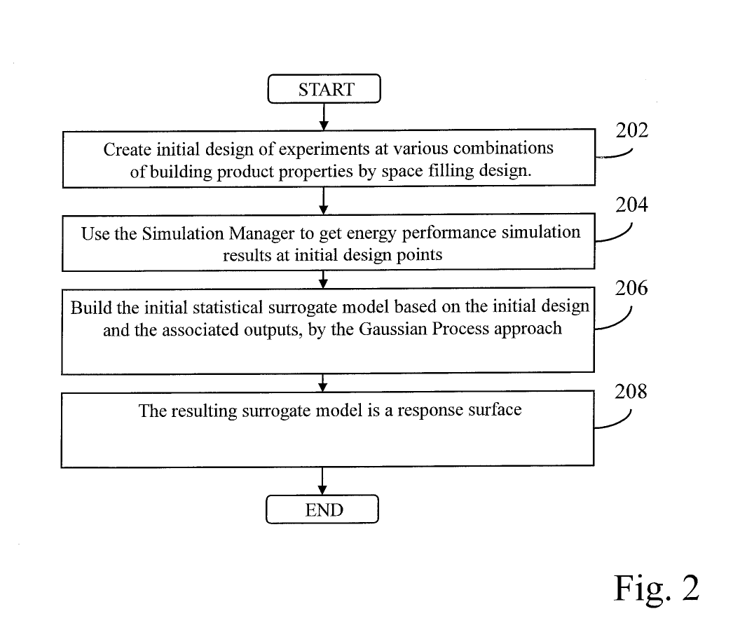

FIG. 2 illustrates a method for initial design in statistical surrogate modeling in one embodiment of the present disclosure. For instance, the components shown in FIG. 1 at 122 may perform the methodology. At 202, initial design of experiments at various combinations of building product properties may be created by space filling design. At 204, a simulation manager tool is used to obtain the energy performance simulation results at initial design points. The energy performance simulation results may be annual results, or another periodic results. At 206, the initial statistical surrogate model is built based on the initial design and the associated outputs, e.g., by the Gaussian process approach as follows: y(•)˜(μ,σ²c(•,•)), where μ is the mean, σ² is the variance, and c(•,•) is the correlation function of the Gaussian process. At 208, the resulting surrogate model represents a response surface, taking the following form: ŷ(x)˜N(\hat{μ}(x),\hat{V}(x)). For example, ŷ(x) would represent energy consumption estimate of a building when the building components x are installed in the building, and \hat{μ}(x) would represent the mean of the estimate, and \hat{V}(x) is the variance of the estimate.

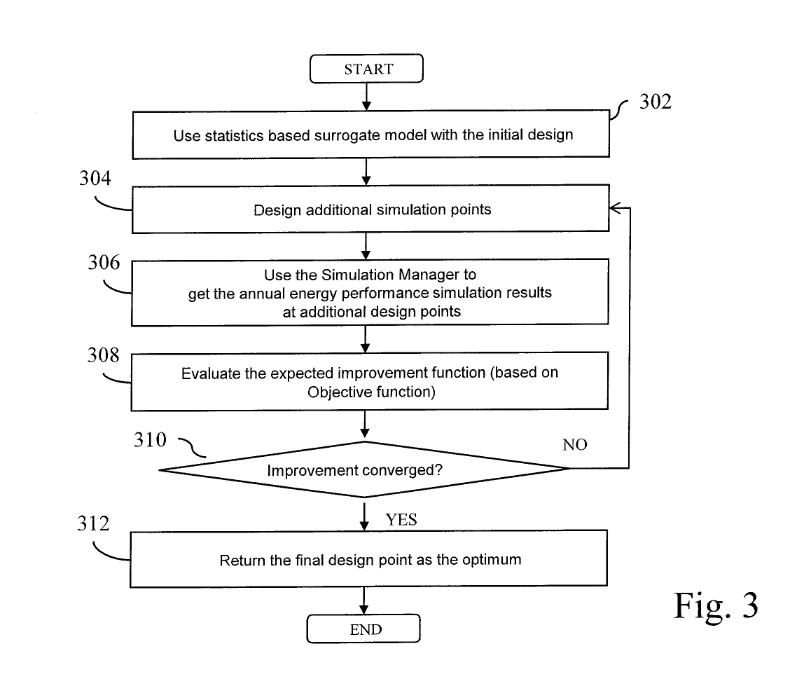

FIG. 3 illustrates a method for sequential design in statistical surrogate modeling in one embodiment of the present disclosure. For instance, the components shown in FIG. 1 at 124 may perform the methodology. The exploration of the design space for optimization may be guided by the expected improvement function in one embodiment of the present disclosure. An example of the improvement function (expected reduction in energy consumption) may include: I(x)=max (fₘᵢₙ−f(x), 0). Here, fₘᵢₙ represents the minimum of the energy consumption computed according to the objective function using a surrogate model refitted from iteration to iteration; f(x) represents the current energy consumption computed in the current iteration according to the objective function using the current surrogate model. Expected improvement is expressed as E[I(x)]. At 302, a statistical surrogate model with initial design, e.g., built in accordance with the method shown in FIG. 2, may be used. At 304, additional simulation points are designed. Additional simulation points may be those that maximize an expected improvement function. At 306, a simulation model (e.g., building simulation tool such as EnergyPlus™) is run with the additional simulation points as input, and energy performance simulation results are obtained as output. At 308, the expected improvement function, e.g., based on an object function is evaluated. In this example, the objective function is to minimize energy consumption of the building, and expected improvement is the uncertainty in the computed energy consumption. Thus, for example, energy consumption is computed using the objective function that incorporates a surrogate model, for each surrogate model. Then energy consumption improvement (or reduction) may be compared for each of the surrogate model. At 310, it is determined whether there is converging of improvement in data. If it is determined that the improvement is converging, at 312, the design points used in the latest simulation are output as recommended combination of building components. If it is determined that the improvement is not converging, the logic of the method returns to 304, where additional simulation points are designed, and the processing at 306, 308, 310 are repeated. The energy performance simulation results at additional design points may then be used to update the surrogate model.

In one embodiment of the present disclosure, a degradation manager component (e.g., shown in FIG. 1 at 110 models the degradation of materials as x_{i,t}=ρᵢx_{i,t-1}+ε_{i,t}, e.g., based on collected data associated with the building component materials, wherein x_{i,t} represent i-th building property at year t, ρᵢ represents annual (or periodic) degradation factor for the i-th building property, ε_{i,t} represents error or uncertainty associated with a respective i-th building property at year t. For instance, wall insulation and roof insulation may have properties such as thickness and R-value which may degrade over usage and time; infiltration material may be measured by building infiltration factors that also may degrade over time; glass material may have u-factor and solar heat gain properties that may degrade over time. Other building materials may be also considered.

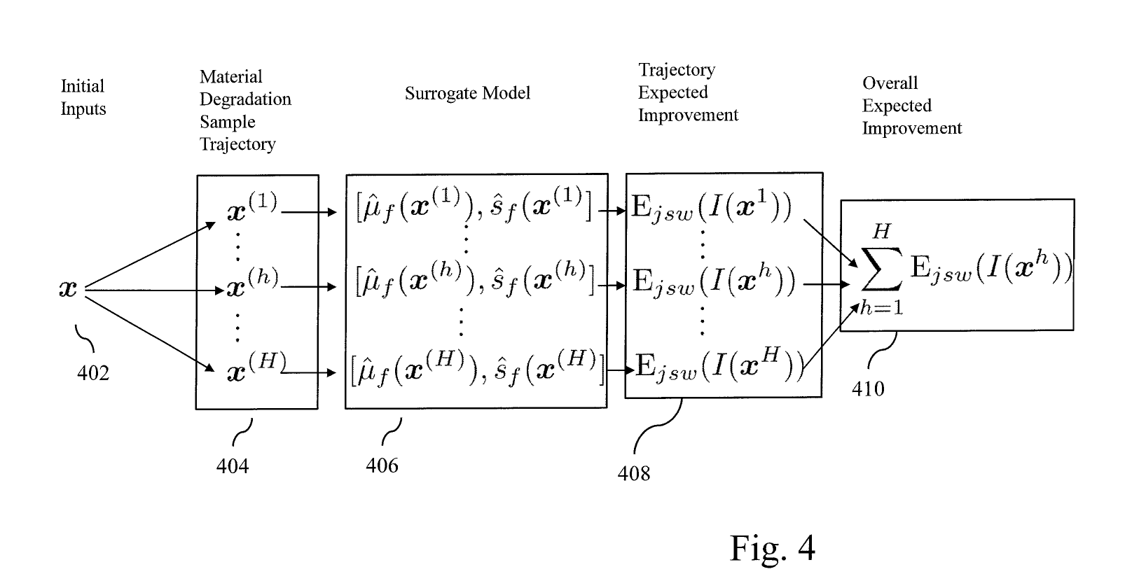

A statistical sequential design for search of good combination of the building products that minimize energy cost function in one embodiment of the present disclosure uses a surrogate model, which reduces computation time. In another aspect, the use of the statistics based surrogate model for physics based simulation models may enable real-time evaluation of energy cost function of combination of building components. Yet in another aspect, material degradation factors over the product life span may be incorporated. Still yet in another aspect, the uncertainty in the material degradation over the product life span may be incorporated. The uncertainty resulting from material degradation may be propagated by performing Monte Carlo studies or the like. FIG. 4 illustrates computation of input uncertainty in material degradation in one embodiment of the present disclosure. The term at 402 represents initial inputs. The terms at 404 represent material degradation sample trajectory. The terms at 406 represent a surrogate model. The terms at 408 represent trajectory expected improvement. e.g., in Jones, Schonlau and Welch, where

$${E}_{jsw} ( I ( x ) ) = ( {f}_{m i n} - {\hat{μ}}_{f} ( x ) ) Φ ( \frac{{f}_{m i n} - {\hat{μ}}_{f} ( x )}{{\hat{s}}_{f} ( x )} ) + {\hat{s}}_{f} φ ( \frac{{f}_{m i n} - {\hat{μ}}_{f} ( x )}{{\hat{s}}_{f} ( x )} ) .$$

The terms at 410 represent the overall expected improvement. In FIG. 4, H represents the number of sampled trajectories, where h=1, 2, 3, . . . , H.

In another aspect of the present disclosure, a computer aided design (CAD) interface may be provided that allows users to select building products from catalogs, e.g., by dragging and dropping the product on a building design, in obtaining suggestion on a good combination of product which minimizes the total spending on investment and operation cost. The CAD interface also may enable user to select building products from catalogs, by dragging and dropping the product on a building design, to obtain real-time evaluation of the corresponding energy performance. The CAD interface further may provide decision support on the good combination of product which minimizes the total spending on investment and operation cost. In addition, the CAD interface may allow a manufacturer to register one or more products and publish real-time energy performance evaluation to customers.

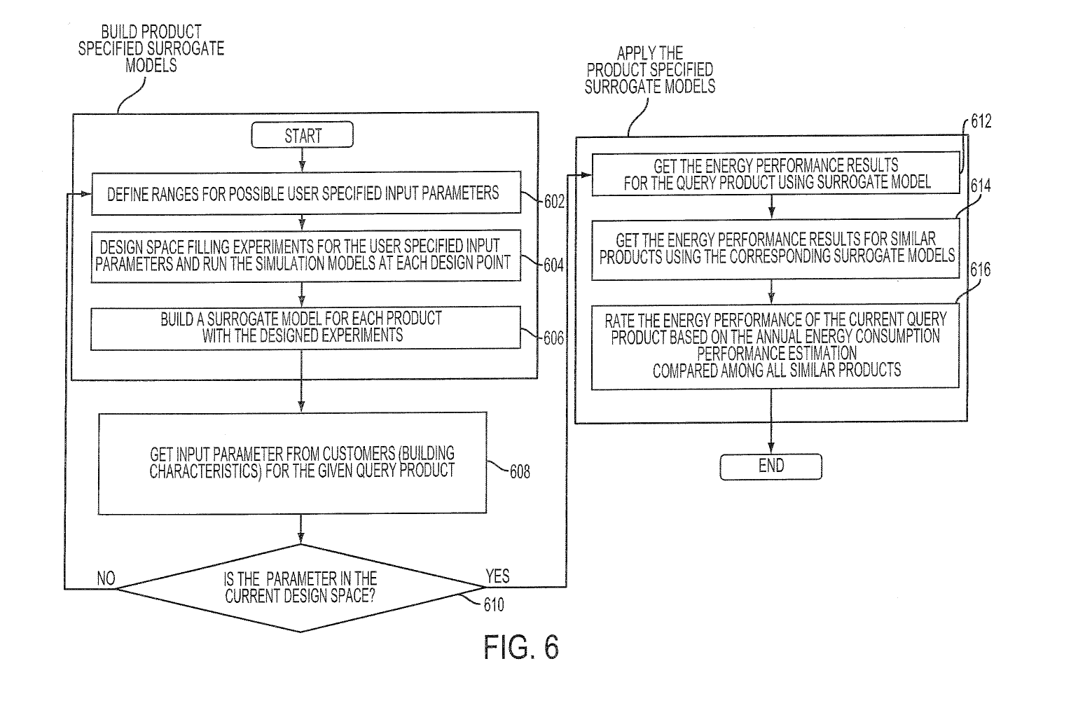

FIG. 6 is a flow diagram illustrating a method for service rendering, e.g., via a CAD interface, for statistic surrogate model in one embodiment of the present disclosure. At 602, ranges are defined for possible user specified input parameters. At 604, space filling experiments are designed for the user specified input parameters and simulation models are run at each design point. At 606, a surrogate model is built for each product with the designed experiments. The processings at 602, 604 and 606 build product specific surrogate models.

At 608, one or more input parameters from customers (building characteristics) are obtained for the given query product (e.g., user specified product). At 610, it is determined whether the input parameter is in the current design space (i.e., the design points used to build the surrogate model. If not, the processing returns to 602, where the ranges for possible user specified input parameters is redefined, and the processing of 604 and 606 repeated. If at 612, it is determined that the input parameter is in the current design space, the surrogate model is used to obtain the energy performance results for the query product. At 614, the energy performance results for similar products using the corresponding surrogate models are obtained. For example, the corresponding surrogate models may have been built according to the processing shown at 602, 604 and 606. At 616, the energy performance of the current query product may be rated based on the annual (or specified periodic) energy consumption performance estimation compared among all similar products.

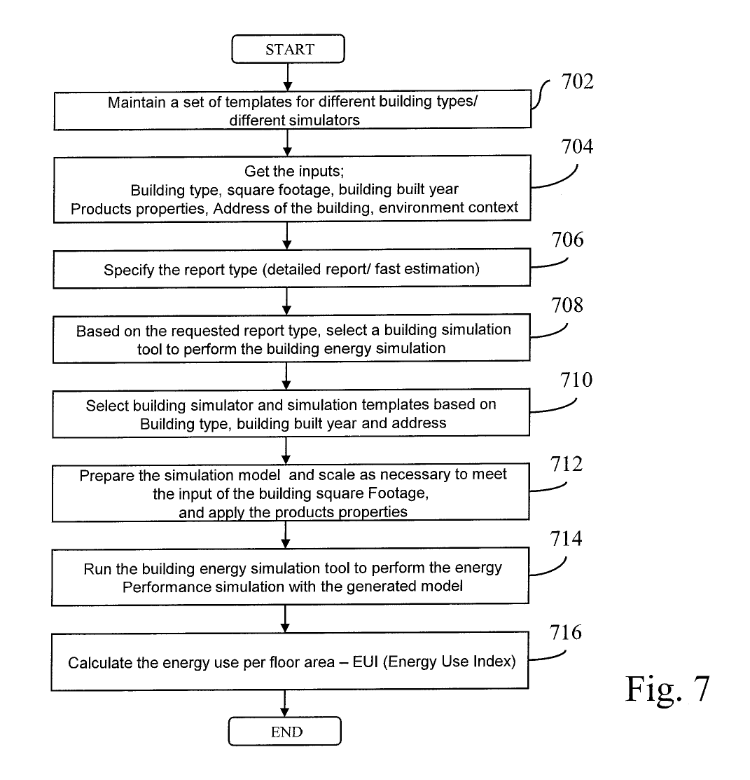

FIG. 7 illustrates a method for service rendering model for building energy simulation model composer in one embodiment of the present disclosure. At 702, a set of templates is maintained for different building types and different simulators. The templates include input parameter formatting information to the respective different simulators. At 704, inputs are obtained. Examples of inputs may include but are not limited to, building type, square footage, building year, product properties, address of the building, environment context, and others. At 706, a type of report to generate is specified, for example, detailed report, fast estimation, e.g., based on user input. At 708, based on the requested report type, a building simulation tool is selected to perform the building energy simulation. At 710, building simulator and simulation templates are selected based on the input values, for example, building type, building built year and address. At 712, the simulation model is prepared and scaled as needed to meet the input of the building square footage, and the product properties are applied. At 714, the selected building energy simulation tool is run to perform the energy performance simulation with the generated model, i.e., prepared at 710 and 712. The building energy simulation tool may be run with a surrogate model as described above.

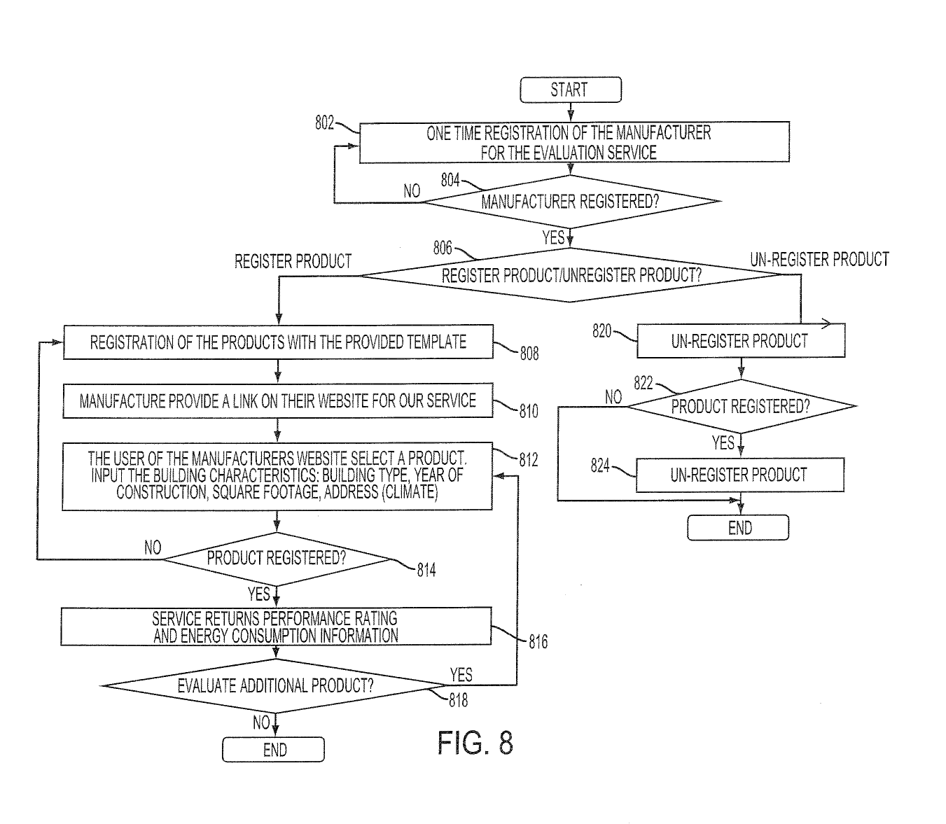

FIG. 8 illustrates a service usage model in one embodiment of the present disclosure. For instance, the service provided according to the method shown in FIG. 8 may be used for building material manufacturers. At 802, one time registration of the manufacturer is performed for the evaluation service. At 804, whether a manufacturer is registered is determined. If not, the registration is performed at 802. At 804, if the manufacturer is registered, it is determined at 806, whether the product is to be registered or unregistered. For product that is to be registered, the logic of the method proceeds to 808. At 808, registration of the product with a provided template is performed. At 810, a manufacturer provided website link is received. At 812, product selection is received from a user of the manufacturer website. Building characteristics are input (e.g., building type, year of construction square footage, address (climate), and/or others. A module on a manufacturer's website may allow user input. At 814, it is determined whether the product is registered. If not registered, the logic of the method returns to 808. If registered, the processing proceeds to 816. At 816, building simulation with surrogate model (e.g., as described above) is performed, and performance rating and energy consumption information is returned. At 818, if additional products remain to be evaluated, the logic of the method returns to 812. Otherwise, the evaluation stops. If at 806, the product is to be unregistered, at 820, the product is unregistered, for example, by determining at 822 whether the product is currently registered, and if so at 824 unregistering the product.

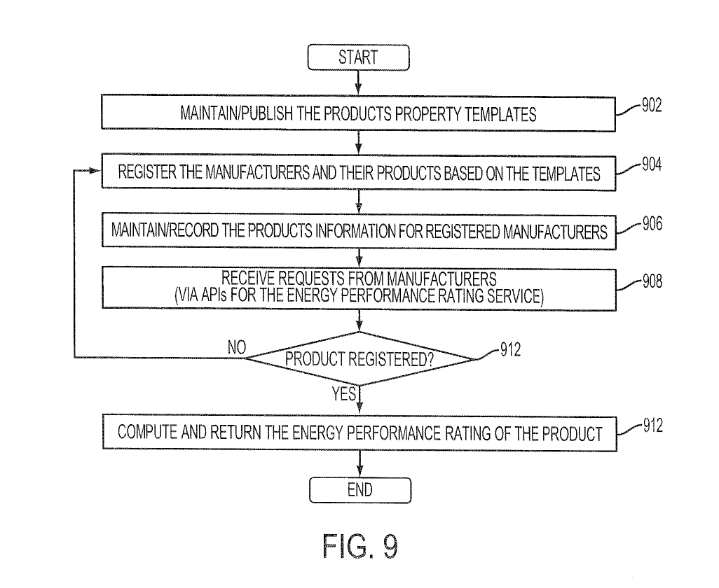

FIG. 9 is a flow diagram illustrating a service rendering model for manufacturers' websites in one embodiment of the present disclosure. At 902, product property templates associated with different products are maintained and/or published. For each product, the template may be different. For a given product the template may comprise a list of properties that are related to building energy consumptions. At 904, a manufacturer and associated one or more manufacturer's products may be registered based on the templates. At 906, the product information for registered manufacturers is maintained and/or recorded. At 908, a request is received from a manufacturer, e.g., via one or more application program interfaces for energy performance rating service. At 910, it is determined whether a product associated with the request is registered. If not, the process returns to 904, where the product and/or the associated manufacturer is registered. At 910, if it is determined that the product is registered, at 912, building energy simulation is run (e.g., with a surrogate model) as described above to compute the energy performance, and the energy performance rating of the product is returned. The ratings may be based on how the product's energy performance fares with other products or other similar products.

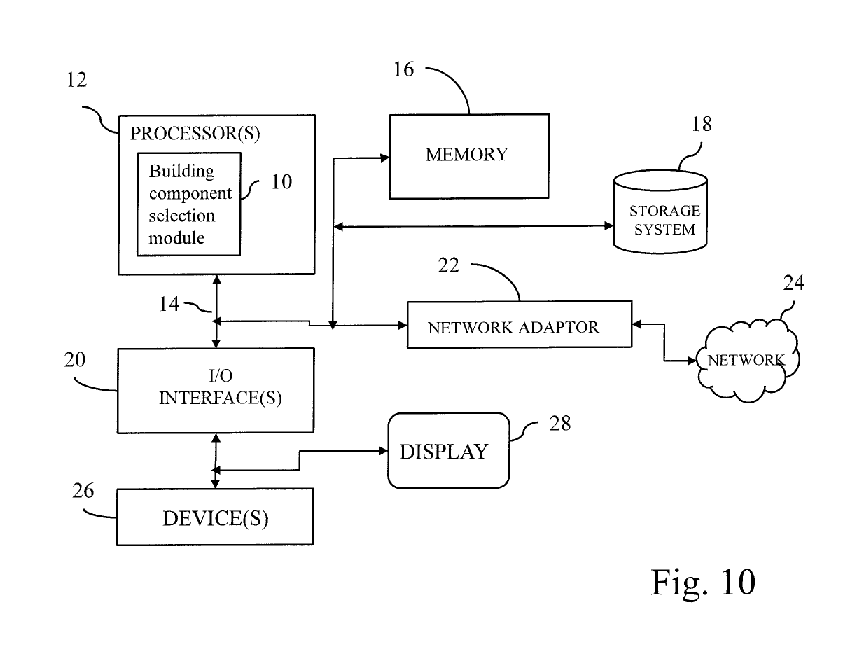

FIG. 10 illustrates a schematic of an example computer or processing system that may implement a building component selection system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 10 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a building component selection module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method of identifying a combination of building components for building installation, comprising:
generating initial design points comprising a combination of building product properties by space-filling design;
obtaining an energy performance simulation result by running a building simulation model at the initial design points;
building a statistical surrogate model based on the initial design points and the energy performance simulation result by a Gaussian process, wherein the Gaussian process represents a response surface that models input-output relationship providing the statistical surrogate model to the building simulation model;
determining new design points comprising a different combination of building product properties to maximize a predefined expected improvement function;
obtaining a new energy performance simulation result by running the building simulation model at the new design points;
refitting the statistical surrogate model to the new energy performance simulation result; and
iterating the determining of new design points, the obtaining of new energy performance simulation result, and the refitting of the statistical surrogate model, until a criterion is satisfied.

2. The method of claim 1, wherein the criterion is satisfied if a difference between energy consumption associated with the new energy performance simulation result computed in a prior and current iterating steps is less than a given threshold.

3. The method of claim 1, wherein the criterion is satisfied if a difference between energy consumption computed using the statistical surrogate model in a prior and current iterating steps is less than a given threshold.

4. The method of claim 1, wherein the criterion is satisfied if a maximum number of the iterating steps have been performed.

5. The method of claim 1, wherein the criterion is satisfied if there is no energy consumption improvement in the new energy performance simulation result in a given number of iterating steps.

6. The method of claim 1, wherein the expected improvement function comprises I(x)=max(fₘᵢₙ−f(x), 0), wherein fₘᵢₙ represents a minimum of the energy consumption computed using the statistical surrogate model out of all iterating steps, and f(x) represents a current energy consumption computed using the statistical surrogate model in current iterating step.

7. The method of claim 1, wherein in each of the iterating step, the statistical surrogate model and a material degradation and associated uncertainty factor are incorporated in building an objective function for finding optimum combination of building product properties.

8. The method of claim 1, wherein the combination of building product properties having most optimal energy performance simulation result is returned.

9. A computer readable storage medium storing a program of instructions executable by a machine to perform a method of identifying a combination of building components for building installation, comprising:
generating initial design points comprising a combination of building product properties by space-filling design;
obtaining an energy performance simulation result by running a building simulation model at the initial design points;
building a statistical surrogate model based on the initial design points and the energy performance simulation result by a Gaussian process, wherein the Gaussian process represents a response surface that models input-output relationship providing the statistical surrogate model to the building simulation model;
determining new design points comprising a different combination of building product properties to maximize a predefined expected improvement function;
obtaining a new energy performance simulation result by running the building simulation model at the new design points;
refitting the statistical surrogate model to the new energy performance simulation result; and
iterating the determining of new design points, the obtaining of new energy performance simulation result, and the refitting of the statistical surrogate model, until a criterion is satisfied.

10. The computer readable storage medium of claim 9, wherein the criterion is satisfied if a difference between energy consumption associated with the new energy performance simulation result computed in a prior and current iterating steps is less than a given threshold.

11. The computer readable storage medium of claim 9, wherein the criterion is satisfied if a difference between energy consumption computed using the statistical surrogate model in a prior and current iterating steps is less than a given threshold.

12. The computer readable storage medium of claim 9, wherein the criterion is satisfied if a maximum number of the iterating steps have been performed.

13. The computer readable storage medium of claim 9, wherein the criterion is satisfied if there is no energy consumption improvement in the new energy performance simulation result in a given number of iterating steps.

14. The computer readable storage medium of claim 9, wherein the expected improvement function comprises I(x)=max (fₘᵢₙ−f(x), 0), wherein fₘᵢₙ represents a minimum of the energy consumption computed using the statistical surrogate model out of all iterating steps, and f(x) represents a current energy consumption computed using the statistical surrogate model in current iterating step.

15. The computer readable storage medium of claim 9, wherein in each of the iterating step, the statistical surrogate model and a material degradation and associated uncertainty factor are incorporated in building an objective function for finding optimum combination of building product properties.

16. The computer readable storage medium of claim 9, wherein the combination of building product properties having most optimal energy performance simulation result is returned.

17. A system for identifying a combination of building components for building installation, comprising:
a processor;
a building component selection module operable to execute on the processor and further operable to generate initial design points comprising a combination of building product properties by space-filling design, the building component selection module further operable to obtaining an energy performance simulation result by running a building simulation model at the initial design points, the building component selection module further operable to build a statistical surrogate model based on the initial design points and the energy performance simulation result by a Gaussian process, wherein the Gaussian process represents a response surface that models input-output relationship providing the statistical surrogate model to the building simulation model, the building component selection module further operable to determine new design points comprising a different combination of building product properties to maximize a predefined expected improvement function, the building component selection module further operable to obtain a new energy performance simulation result by running the building simulation model at the new design points, the building component selection module further operable to refit the statistical surrogate model to the new energy performance simulation result, wherein the building component selection module iterates determining of the new design points, obtaining of the new energy performance simulation result, and refitting of the statistical surrogate model, until a criterion is satisfied.

18. The system of claim 17, wherein the criterion is satisfied if one or more of following condition is met: a difference between energy consumption associated with the new energy performance simulation result computed in a prior and current iterating steps is less than a given threshold; a difference between energy consumption computed using the statistical surrogate model in a prior and current iterating steps is less than a given threshold; a maximum number of the iterating steps have been performed; or there is no energy consumption improvement in the new energy performance simulation result in a given number of iterating steps; or a combination thereof.

19. The system of claim 17, wherein the expected improvement function comprises I(x)=max (fₘᵢₙ−f(x), 0), wherein fₘᵢₙ represents a minimum of the energy consumption computed using the statistical surrogate model out of all iterating steps, and f(x) represents a current energy consumption computed using the statistical surrogate model in current iterating step.

20. The system of claim 17, wherein in each of the iterating step, the statistical surrogate model and a material degradation and associated uncertainty factor are incorporated in building an objective function for finding optimum combination of building product properties.
